(19) United States
(12) Patent Application Publication
(10) Pub. No.: US 2009/0149264 A1
(43) Pub. Date: Jun. 11, 2009

(54) Accommodation housing for homokinetic joints

(76) Inventor: Henning Raguschke, Ackendorf (DE)

Correspondence Address: COLLARD & ROE, P.C., 1077 NORTHERN BOULEVARD, ROSLYN, NY, 11576, US

(21) Appl. No.: 12/316,016

(22) Filed: Dec. 9, 2008

(30) Foreign Application Priority Data
Dec. 10, 2007 (DE) 10 2007 059 637.7
Dec. 3, 2008 (DE) 10 2008 060 329.5

(51) Int. Cl. F16D 3/224

(52) U.S. Cl. 464/152

(57) ABSTRACT

An accommodation housing for homokinetic joints, which are configured as fixed joints or displacement joints, for use in motor vehicles, to transfer torque. The tied-in homokinetic joints are connected with the accommodation housing by way of their outer rings. The accommodation housing consists of an accommodation housing part having a closure lid disposed in the accommodation housing part. A homokinetic joint is disposed in the accommodation housing part with force fit and shape fit, by way of the outer ring, relative to the inside wall of the accommodation housing part, and both the accommodation housing part and the closure lid are configured with connection elements having different structures.

### CROSS REFERENCE TO RELATED APPLICATIONS

Applicant claims priority under 35 U.S.C. 119 of German Application No. 10 2007 059 637.7 filed Dec. 10, 2007 and German Application No. ______ filed Dec. 3, 2008.

### BACKGROUND OF THE INVENTION

1. Field of the Invention

The invention relates to an accommodation housing for homokinetic joints, which are configured as fixed joints or displacement joints, for use in motor vehicles, to transfer torque.

2. The Prior Art

Arrangements of homokinetic joints in accommodation housings or accommodation parts are known from the state of the art. For example, German Patent No. 40 42 390 C2 describes a fixed homokinetic joint that is inserted into a sleeve or a bell, so as to rotate with it. The bell supports the outer part of the homokinetic joint in the radial direction, and in order to achieve a torque-proof connection, recesses are made in one of the face surfaces that form the opening sides, so that after the homokinetic joint has been pushed into the bell, the latter is deformed in such a manner that the joint penetrates into the recesses, and thus a torque-proof connection is supposed to be produced.

This solution involves a special case in which a specially configured homokinetic joint finds accommodation in the bell, and thus multiple use of this solution is not possible.

An arrangement with a homokinetic joint and an accommodation part is described in German Patent No. DE 199 11 113 C1, in which the homokinetic joint possesses centering surfaces on its outer surface, with which the outer part is supposed to be centered in a centering bore of the accommodation part and the outer part is connected with an accommodation part by way of a flange.

The outer part is formed from a metal sheet, possesses-a formed-on flange on its axial end, and has a cylindrical centering surface toward the other axial end. Furthermore, the flange has passage bores for attachment screws, and is configured with an accommodation part. The outer part is connected with the accommodation part by way of attachment screws and threaded bores.

It is a disadvantage of this solution that the completely assembled homokinetic joint is a so-called open homokinetic joint before it is installed, and thus is not protected from contaminants during storage and installation. Furthermore, it is not guaranteed that lubricant that has already been introduced into the homokinetic joint can exit.

A closed system is only implemented when the homokinetic joint is installed relative to the accommodation part. This homokinetic joint can also be inserted only into a specially configured accommodation part, so that no variability exists.

### SUMMARY OF THE INVENTION

It is therefore an object of the invention to further develop an accommodation housing for homokinetic joints so that homokinetic joints configured as a fixed joint or as a displacement joint can be inserted, and find accommodation, sealed on both sides, and can be disposed directly related to other modules.

This task is accomplished according to the invention by an accommodation housing which consists of an accommodation housing part having a closure lid, such that a homokinetic joint, configured as a fixed joint or a displacement joint, can be inserted into the accommodation housing part, is connected with force fit and shape fit with the inside wall of the accommodation housing part, by way of the outer ring, and is sealed by the closure lid on the left side, for example towards the transmission side of a motor vehicle transmission. In the opposite side of the accommodation housing, the homokinetic joint is sealed by way of a folded bellows.

Both the accommodation housing part and the closure lid disposed in it, in fixed or interchangeable manner, are configured with connection elements having different structures, by way of which the accommodation housing is connected/linked with other units, for example a transmission.

The homokinetic joints that are used are configured in known manner, and consist of an inner part and an outer ring, between which the cage with the roller bodies that circulate in it is provided. In this connection, the roller bodies run in running grooves that are provided both in the inner part and in the outer ring of the homokinetic joint.

The configurations of the raceways are structured in accordance with the type of homokinetic joint, so that these can be used as fixed joints or as displacement joints.

The arrangement and locking of the homokinetic joint in the accommodation housing takes place by way of grooves and driver projections that are disposed in the outer ring of the homokinetic joint and on the inside wall of the accommodation housing part, in such a manner that the homokinetic joint is fixed in place on the driver projections of the accommodation housing part, by way of its outer ring. In this connection, fixation of the outer ring in the axial direction takes place, on the one side, by way of the projection of the driver housing part, and on the opposite side, by means of the inserted closure lid, which acts on the outer ring of the homokinetic joint with its outer collar, where the ring rests against the projection of the driver housing part, towards the driver housing part. Thus, fixation and locking of the homokinetic joint is guaranteed.

The connection of an accommodation housing with integrated homokinetic joint to a module of a motor vehicle, for example a transmission or a shaft, for example a cardan shaft, takes place by way of the specially configured connection elements of this arrangement, which are provided on the left and right side at the face side of the accommodation housing part and the closure lid.

According to the invention, the connection elements are structured in the form of flange eyes or in the form of welded projections. If flange eyes are used, they are disposed on the outer circumference of the accommodation housing part, as a function of the hole patterns of the transmission. The accommodation housing with the homokinetic joint is attached to the transmission, by way of screws that can be pushed through. There is the advantage that easy assembly and disassembly are guaranteed by this screw connection, and the replaceability of possible wear parts can also be implemented without great disassembly effort.

In another embodiment, the connection elements of the accommodation housing are configured as welded projections, which are provided on the accommodation housing part and on the closure lid. In the case of this embodiment, the homokinetic joint is welded onto a pipe of a shaft, for example a cardan shaft, and the connection to the transmission takes place by way of the inner part of the homokinetic joint.

With this configuration of the attachment possibilities, a uniform homokinetic joint can be universally used in the accommodation housing. The joint provided in the accommodation housing is completely encapsulated both by the accommodation housing part and by the closure lid situated in it and the folded bellows, and thus protected from outside influences.

Other advantages of the invention are established by arranging the closure lid in the accommodation housing part, in releasable or permanent form, depending on whether or not regenerability, i.e. the ability to be broken down into individual parts, is desired.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a sectional view of an accommodation housing with an integrated homokinetic joint;

FIG. 2 shows individual parts and individual partial groups, respectively, of the representation according to FIG. 1, in a sectional view;

FIGS. 3a and 3b show, in two exploded drawings, the individual parts of individual partial modules, in a perspective view and in a half-sectional representation according to FIG. 1,

FIG. 4 shows a sectional representation of an accommodation housing with an integrated homokinetic joint, with connection elements configured as welded projections;

FIG. 5 shows individual parts and individual partial groups, respectively, of the representation according to FIG. 4, in a sectional view; and

FIGS. 6a and 6b show, in two exploded drawings, the individual parts and the individual partial modules, in a perspective view and in a half-sectional representation according to FIG. 4.

### DETAILED DESCRIPTION OF THE PREFERRED EMBODIMENT

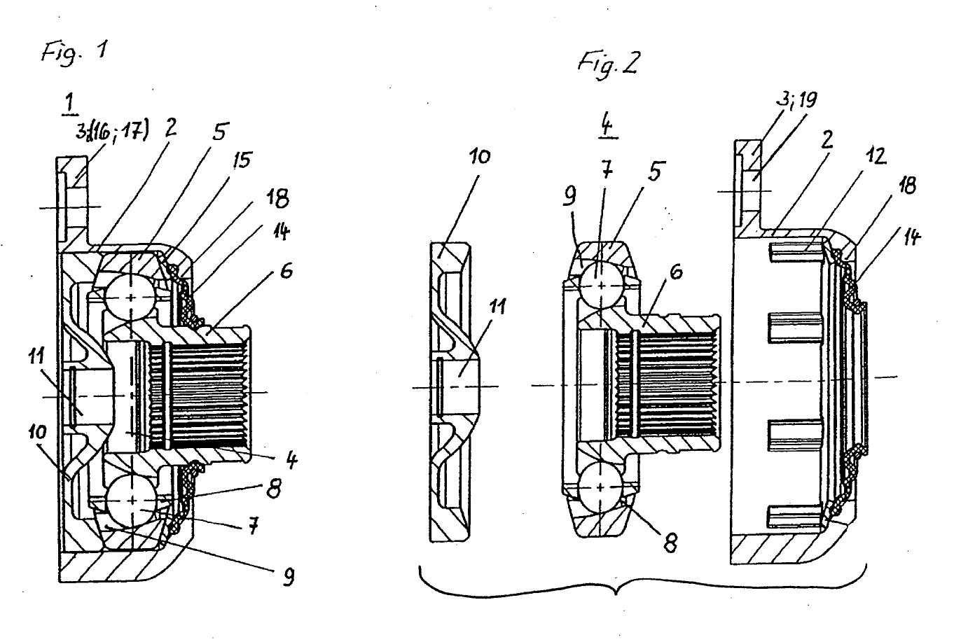

Referring now in detail to the drawings, the accommodation housing 1 with an inserted homokinetic joint 4, here configured as a fixed joint, is shown in its totality in FIG. 1, and in individual parts and individual partial groups, respectively, in FIG. 2; reference is made to these figures below.

Thus, the configuration of accommodation housing 1 is evident from the representations of FIGS. 1 and 2; this housing is structured in pot shape, due to the configuration of the accommodation housing part 2, which is configured with a projection 18 on the right side, in the direction of a longitudinal shaft that is to be connected.

On the opposite side, accommodation housing 1 is configured in a planar manner. This is the connection side of accommodation housing 1 to a unit of a motor vehicle, for example for connection to a transmission.

A closure lid 10 is disposed in accommodation housing part 2; it can be inserted into accommodation housing part 2 both in fixed manner and in interchangeable manner.

On the flange side of the connection side of accommodation housing 1, accommodation housing 1 is configured with connection elements 3; 16; 17, by way of which accommodation housing 1, with the homokinetic joint 4 disposed in it, can be attached to a transmission or another module.

Homokinetic joint 4 consists, in known manner, of an inner part 6 and an outer ring 5; both parts are configured with raceways 9 in which roller bodies 7 are disposed, guided by means of a cage 8 that is provided. Raceways 9 are curved and impart a certain mobility to the homokinetic joint, which can be fixed in place in the shape of a bent bracket.

Closure lid 10 is shown in the representation on the left of FIG. 2, and in this embodiment possesses a centering bore 11, by means of which entire accommodation housing 1, including the homokinetic joint 4, can be positioned relative to a journal of a transmission. This is an embodiment possibility that can be structured optionally, upon customer request or if needed, as a function of the use of the homokinetic joint 4 with the accommodation housing 1.

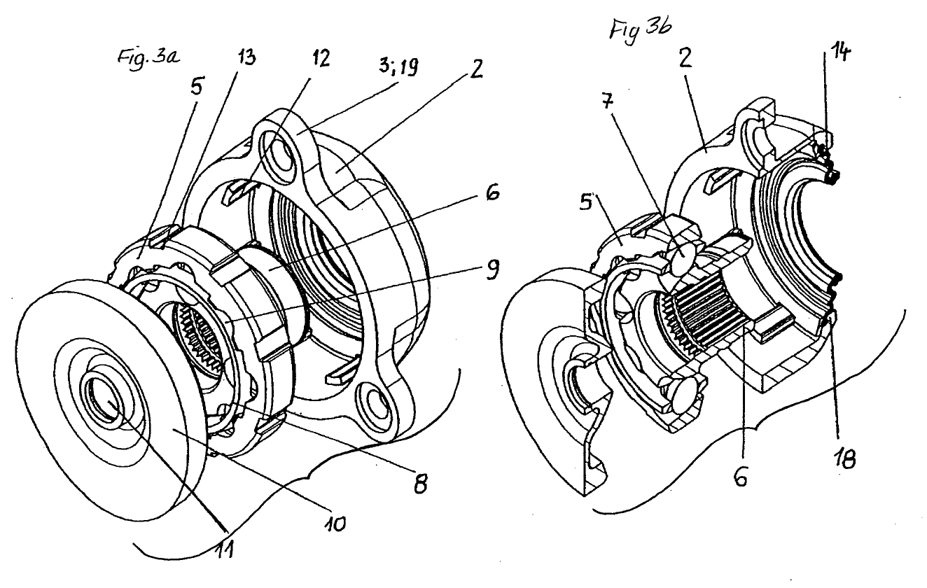

The configuration of the accommodation housing 1 is evident from the representation on the right according to FIG. 2, in which it is shown that driver projections 12 are disposed in the accommodation housing part 2, on its inside wall, relative to which homokinetic joint 4 to be inserted can be inserted with its grooves 13 provided in outer ring 5, with shape fit and force fit. The configuration and placement of grooves 13 in outer ring 3 is shown in detail in FIG. 3.

In addition to the placement of homokinetic joint 4 in accommodation housing 1, the fixation and sealing of homokinetic joint 4 in accommodation housing part 2 are also evident from FIG. 1. This takes place in such a manner that when homokinetic joint 4 is inserted into accommodation housing part 2, outer ring 5 of homokinetic joint 4 comes to rest on projection 18 on the right side, and on the left side, outer ring 5 is fixed in place and locked by means of inserted closure lid 11.

The present invention has the advantage that if necessary, a damping element can be inserted between homokinetic joint 4 and accommodation housing part 2, in order to reduce noise and to uncouple homokinetic joint 4 relative to accommodation housing part 2.

As is shown in FIG. 1 and also in the representation on the right in FIG. 2, a folded bellows 14 is provided to seal homokinetic joint 4 on the right side, which bellows is attached, for one thing, on outer collar of inner part 6 of homokinetic joint 4, and, for another, between projection 18 and inserted homokinetic joint 4, in its outer region.

As was already explained above, accommodation housing 1 is configured with connection elements 3; 16; 17, by way of which accommodation housing 1 with homokinetic joint 4 inserted in it can be attached to other modules. The representations according to FIGS. 1 and 2 show the configuration of connection element 3 in the form of flange eyes 19, which are disposed on the accommodation housing part 2 on its circumference.

In the perspective view according to FIG. 3, the configuration and placement of connection elements 3 in the form of flange eyes 19 is shown particularly clearly.

From this FIG. 3, it is also evident how grooves 13 are positioned from outer ring 5 to driver projections 12, when homokinetic joint 4 is joined into accommodation housing part 2, and after joining, a shape-fit and force-fit connection between driver/accommodation housing part 2 and homokinetic joint 4 is then achieved. Sealing and closing of accommodation housing 1 and the inserted homokinetic joint 4 take place by way of closure lid 10, which is inserted into accommodation housing part 2 of accommodation housing 1.

The illustration on the right in FIG. 3 shows how the individual functional parts are joined to one another, and it is also shown that folded bellows 14 is inserted between outer ring 5 and outer projection 18 of accommodation housing part 2. It is also evident that folded bellows 14 can be attached to inner part 6 when homokinetic joint 4 has been inserted into accommodation housing part 2, relative to the latter.

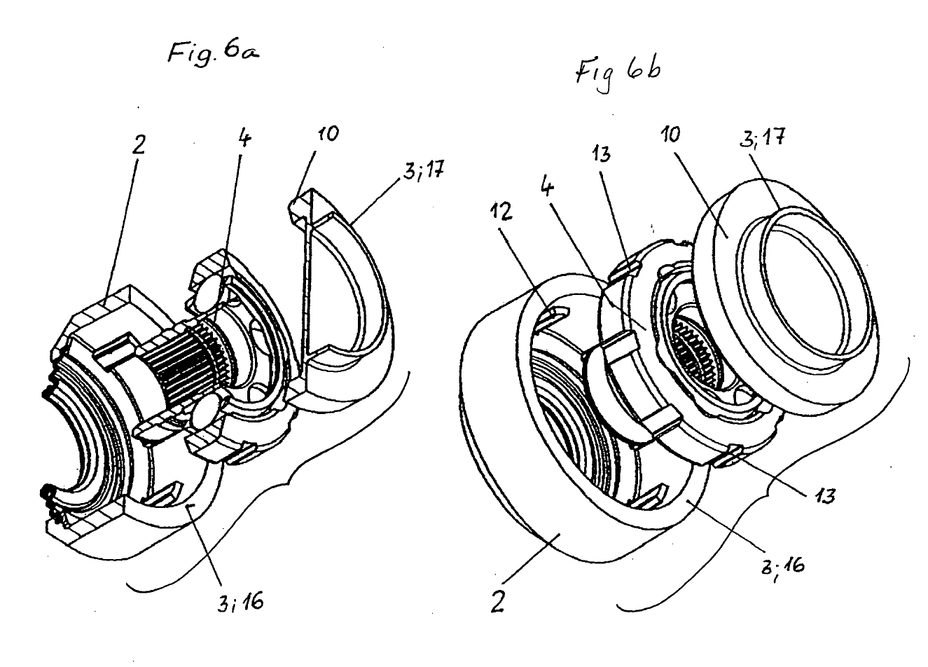

The configuration and the placement of connection elements 16; 17 for attaching or connecting accommodation housing 1 with homokinetic joint 4 to a transmission or a shaft, for example, is shown in FIGS. 4 to 6, from which it is furthermore evident that accommodation housing 1 with homokinetic joint 4 disposed in it corresponds to the embodiment as described above and shown in FIGS. 1 to 3. With this embodiment as well, the connection to a transmission takes place by way of inner part 6 of homokinetic joint 1.

The representations of FIGS. 4 to 6 explain how connection elements 16; 17 are configured, and how accommodation housing 1 with homokinetic joint 4 inserted in it can be connected with another component, for example a shaft, by way of the connection elements 16; 17 that are configured as welded projections, thereby creating variability and broad use of the solution that is created.

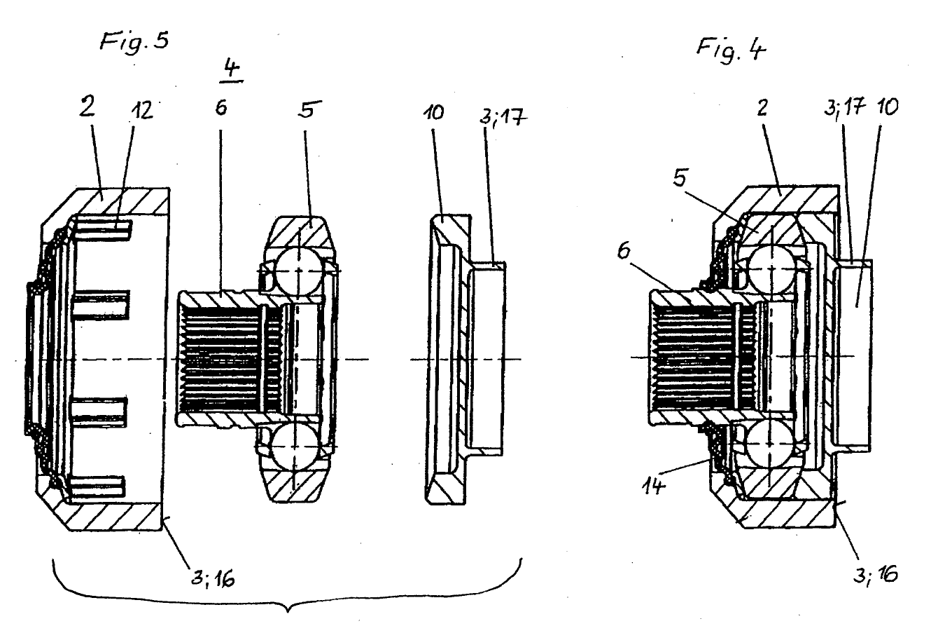

Thus, in FIGS. 4 to 5, the configuration and placement of connection elements 3 in the form of welded projections 16; 17 are shown; these are provided on the right side on driver housing part 2 and on closure lid 10.

Thus, there is the possibility that accommodation housing 1 with homokinetic joint 4 inserted in it can be directly connected with another component/module, by means of a welding process, by way of welded projection 16.

Another embodiment variant of the connection of accommodation housing 1 with a functional module takes place by way of welded projection 17, which is provided on the right side on the planar part of closure lid 10.

In the configuration of closure lid 10 with welded projection 17, closure lid 10 is configured to have a full area, so that in any case, it is guaranteed that homokinetic joint 4 that is provided and inserted in accommodation housing 1 is also sealed, and protected from contaminants.

As a result of the different configuration of connection elements 3, 16, 17 of accommodation housing 1, and because of its construction, different fixed joints or displaceable joints of different types can be used, thereby making it possible to implement a plurality of combination possibilities for connecting longitudinal shafts with other modules of motor vehicles, using only a few components/modules.

Accordingly, while only a few embodiments of the present invention have been shown and described, it is obvious that many changes and modifications may be made thereunto without departing from the spirit and scope of the invention.

What is claimed is:

1. A combination homokinetic joint and an accommodation housing for the homokinetic joint for use in motor vehicles, to transfer torque, comprising:
an accommodation housing part;
a closure lid disposed in the accommodation housing part; and
a homokinetic joint having an outer ring and being disposed in the accomodation housing part with force fit and shape fit, by way of the outer ring, relative to an inside wall of the accommodation housing part,
wherein both the accommodation housing part and the closure lid are configured with connection elements having different structures.

2. The accommodation housing according to claim 1, further comprising driver projections disposed on the inside wall of the accommodation housing part, in a circumferential arrangement and at fixed intervals, and wherein the outer ring of the homokinetic joint is configured to have grooves that correspond to the driver projections.

3. The accommodation housing according to claim 1, wherein the closure lid is configured in closed form or with a centering bore.

4. The accommodation housing according to claim 1, wherein the accommodation housing part is pot-shaped and wherein the closure lid is disposed in the accommodation housing part in fixed or interchangeable manner, forming a seal, said accommodation part fixing the outer ring in place axially, said outer ring resting against a projection of the accommodation housing part.

5. The accommodation housing according to claim 1, wherein the homokinetic joint is sealed in a direction towards a longitudinal shaft, by a tied-in folded bellows.

6. The accommodation housing according to claim 1, wherein the connection element of the accommodation housing part is configured as a flange connection in the form of flange eyes disposed on an outer circumference of the accommodation housing part.

7. The accommodation housing according to claim 1, wherein the connection element on the accommodation housing part is configured as a welded projection configured on a face side of the accommodation housing.

8. The accommodation housing according to claim 1, wherein the connection element on the closure lid is configured as a welded projection structured in ring shape on the closure lid.
